(19) United States
(12) Patent Application Publication
(10) Pub. No.: US 2024/0159959 A1
(43) Pub. Date: May 16, 2024

(54) SYSTEM AND METHOD OF FABRICATING LOW-LOSS AND LOW-NOISE WAVEGUIDES FOR VISIBLE WAVELENGTH APPLICATIONS

(71) Applicant: United States Department of Energy, Washington, DC (US)

(72) Inventors: Benjamin T. Chorpening, Pittsburgh, PA (US); Michael P. Buric, Pittsburgh, PA (US); Juddha Thapa, Pittsburgh, PA (US)

(21) Appl. No.: 18/510,819

(22) Filed: Nov. 16, 2023

Related U.S. Application Data
(60) Provisional application No. 63/425,764, filed on Nov. 16, 2022.

(51) Int. Cl. G02B 6/032; C03C 25/106

(52) U.S. Cl. CPC G02B 6/032; C03C 25/1063; C03C 2217/256; C03C 2218/11

(57) ABSTRACT

One or more embodiments relates to a system for producing a waveguide, a method of making a waveguide and a waveguide having low surface roughness, adapted to minimize loss and noise while producing a circular beam that can be used in the visible or short-wave spectral regime. The waveguide includes a glass capillary tube having an outer surface and an inner surface defining a hollow core; a metal layer deposited on at least the inner surface; and a polymer layer overcoat deposited on at least the metal layer and in fluid communication with the hollow core.

### CROSS-REFERENCE TO RELATED APPLICATION

This application claims the benefit of and priority to U.S. Provisional Patent Application Ser. No. 63/425,764 filed Nov. 16, 2022, the complete subject matter of which is incorporated herein.

### STATEMENT OF GOVERNMENT SUPPORT

The United States Government has rights in this invention pursuant to the employer-employee relationship of the Government to the inventors as U.S. Department of Energy employees and site-support contractors at the National Energy Technology Laboratory.

### FIELD OF THE INVENTION

Embodiments relate to waveguides. More specifically embodiments relate to low-loss and low-noise hollow waveguides.

### BACKGROUND

Hollow waveguides are essentially long tubes lined with reflective coatings used to transmit light down the central bore. They are generally produced with central bores in the range of 200 μm-1 mm. These waveguides are easy to fabricate with high internal surface roughness for infrared applications.

Hollow glass waveguides with larger internal diameters (≥500 μm) are commercially available. However, high optical quality small internal diameter hollow waveguides (between about 300 μm and 500 μm) are not commercially available for visible wavelengths. Commercially available waveguides having an internal diameter of about 300 μm have larger internal surface roughness, higher laser power loss, and produce fluorescence when pumped with a laser source (which reduces the available signal-to-noise (SNR) ratio in Raman applications). The hollow waveguides currently fabricated by commercial vendors are optimized for infrared laser beam delivery applications and not for Raman spectroscopic applications.

The most popular method for producing internally reflective hollow waveguides is electroless deposition. The vast majority of hollow waveguides are produced using the Tollens reaction, which produces a thin silver coating. The internal roughness in commercial waveguides is due to the method by which this internal coating is applied. Various parameters in the hollow waveguide fabrication procedure include coating system arrangement, chemical concentration of the pretreatment and coating chemicals, coating time, temperature, pressure, etc. Many of these parameters must be

As provided previously, hollow waveguides may b e used in a Raman system such as Raman gas detection system and analyzer 10 developed at NETL disclosed in U.S. Pat. No. 8,674,306; issued on Mar. 18, 2014, and as illustrated in FIG. 1.

FIG. 1 depicts system 10 with power meter 12 coupled to capillary waveguide 24 (a metal-lined capillary waveguide) through valve 14. As shown, valve 14 includes gas in port 16, gas out port 18 enabling gas bypass, input port 20, and output port 22. System 10 includes a high-pressure gas-output flange 26 having gas output port 28, and pressure window 30 in communication with the waveguide 24. One or more optical beams are output by the high-pressure gas-output flange 26 via pressure window 30 which then pass through a first achromatic lens 32 (a 50 mm lens for example) and engage a dichroic beam splitter 34. The beam splitter 34 is coupled to a laser line cleanup filter 36 and a pump laser 38. As shown, a least a portion of the beam passes through long pass filter 40 and a second achromatic lens 42 (a 50 mm lens for example). The beam passes through the lens 42 and engages a fiber bundle 44 which is coupled to a spectrometer 46, a charged coupled device 48, and a computer 50.

A need exists in the art for a waveguide with a low surface roughness, adapted to minimize loss and noise while producing a circular beam that can be used in the visible or short-wave spectral regime.

### SUMMARY

One or more embodiments relate to a waveguide having low surface roughness, adapted to minimize loss and noise while producing a circular beam that can be used in the visible or short-wave spectral regime. The waveguide includes a glass capillary tube having an outer surface and an inner surface defining a hollow core; a metal layer deposited on at least the inner surface; and a polymer layer overcoat deposited on at least the metal layer and in fluid communication with the hollow core.

Yet another embodiment relates to a system for forming a waveguide having low surface roughness which is adapted to minimize loss and noise while producing a circular beam that can be used in the visible or short-wave spectral regime. The system includes a constant temperature water bath adapted to receive one or more hollow glass capillary tubes and reduce the temperature of the one or more glass capillary tubes to about 10° C.-15° C. and at least one bypass/crossover valve in fluid communication with the constant temperature water bath. The system further includes a first high-pressure syringe pump in fluid communication with the at least one bypass/crossover valve and a first reservoir containing a Tollens solution; and a second high-pressure syringe pump in fluid communication with the at least one bypass/crossover valve and a second reservoir containing a reducer solution.

Still another embodiment relates to a method for forming a waveguide having low surface roughness which is adapted to minimize loss and noise while producing a circular beam that can be used in the visible or short-wave spectral regime. The method includes reducing and controlling the temperature of one or more glass capillary tubes to about 10° C.-15° C.; cleaning and treating at least an interior of the one or more glass capillary tubes; activating the interior of the one or more glass capillary tubes; and adhering a silver metal to the interior of the one or more glass capillary tubes.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 depicts a schematic of a known gas sensing system employing Raman Scattering;

FIG. 2 depicts an end view of a waveguide in accordance with one embodiment of the present invention which may be used with the gas sensing system of FIG. 1 for example;

FIG. 3 depicts a partial cutaway view of the waveguide of FIG. 2 in accordance with one embodiment of the present invention;

FIG. 4 depicts a longitudinal view of the waveguide of FIGS. 2-3 in accordance with one embodiment of the present invention;

FIG. 5 depicts a longitudinal view of a hollow capillary used in producing the waveguide of FIGS. 2-4 in accordance with one embodiment of the present invention;

FIG. 6 depicts a schematic of a hollow waveguide deposition system used to produce the waveguides of FIGS. 2-4 in accordance with one embodiment of the present invention;

FIG. 7 depicts a flowchart illustrating one method of making a waveguide of FIGS. 2-4 in accordance with one embodiment of the invention;

FIGS. 8A-8C depict plots illustrating Raman spectra of air from three waveguides of internal diameter 300 μm where FIG. 8A depicts a plot illustrating a known waveguide with higher noise and low SNR, FIG. 8B depicts a plot illustrating a known waveguide with low noise and low SNR, and FIG. 8C depicts a plot illustrating a waveguide in accordance with one embodiment of the present invention with low noise and high SNR.

### DETAILED DESCRIPTION

The foregoing summary, as well as the following detailed description of certain embodiments of the present invention, should be read with reference to the drawings in which similar elements in different drawings are numbered the same. The drawings, which are not necessarily to scale, depict illustrative embodiments and are not intended to limit the scope of the invention.

One or more embodiments relates to a method of fabricating a hollow glass waveguide of high optical quality and a hollow glass waveguide made by such a method which can be used in the visible or short-wave spectral regime for applications like Raman spectroscopy or laser beam delivery. Uncoated hollow capillaries made of silica glass can be used to transmit light but suffer high scattering losses and result in annular beams. To minimize the loss and ensure a circular beam, the internal surface of the capillary tube is enhanced by plating it with one or more metals such as silver. The silver coating effectively reflects the light and transmits it from the proximal end to the distal end.

There are various patents and literature on fabricating hollow waveguides for IR applications. Some of these reported fabrication methods include vacuum or peristaltic pumping to introduce metal-precursor chemicals. All of these methods result in high internal surface roughness making them unsuitable for visible-wave applications. NETL has constructed a new system of electroless deposition for internal waveguide coatings that produces low surface roughness for visible-wave waveguides.

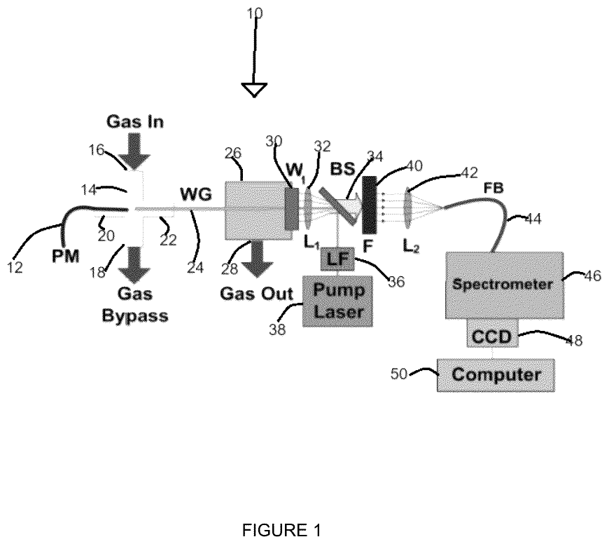

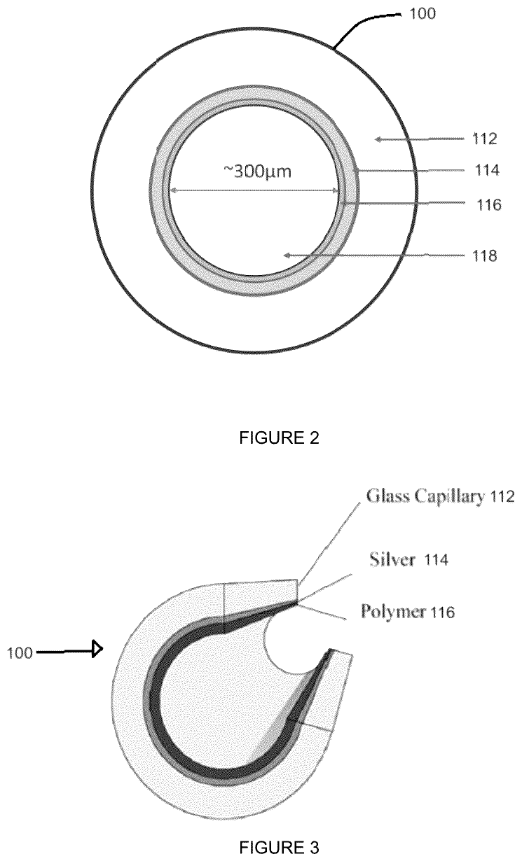

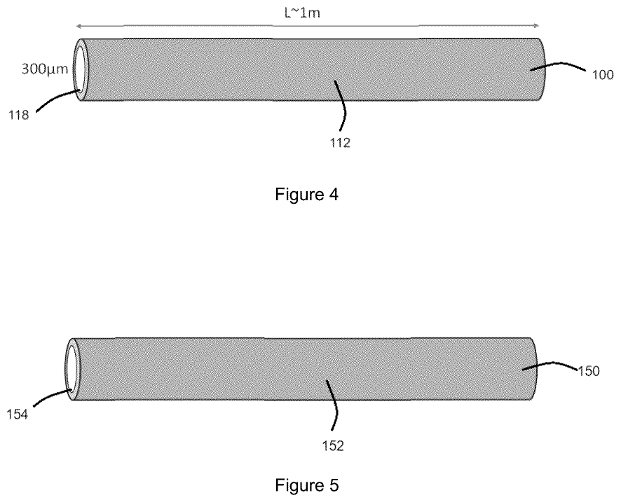

FIGS. 2-3 depict various views of a waveguide 100 in accordance with one embodiment of the present invention which may be used with a gas sensing system of FIG. 1 for example. FIGS. 2-3 depict a hollow capillary tube 112 (semi-flexible glass capillary for example) having an outer surface and an inner surface defining a hollow core 118. A metal layer 114 (a silver metal plate for example) is plated on at least the inner surface, and a polymer layer overcoat 116 (a cyclic olefin copolymer/dielectric for example) is deposited on at least the metal layer 114 and in fluid communication with the hollow core 118. As illustrated the hollow core has a diameter ranging between 300 μm and 500 μm but is generally about 300 μm. FIG. 4 depicts the waveguide 100 and the glass capillary tube 112 are about 1 meter in length.

FIG. 5 depicts a longitudinal view of a hollow capillary 150 (a semi-flexible glass capillary for example) having an exterior surface 152 and an interior surface 154. Capillary 150 may be used in producing the waveguide of FIGS. 2-4 in accordance with one embodiment of the present invention.

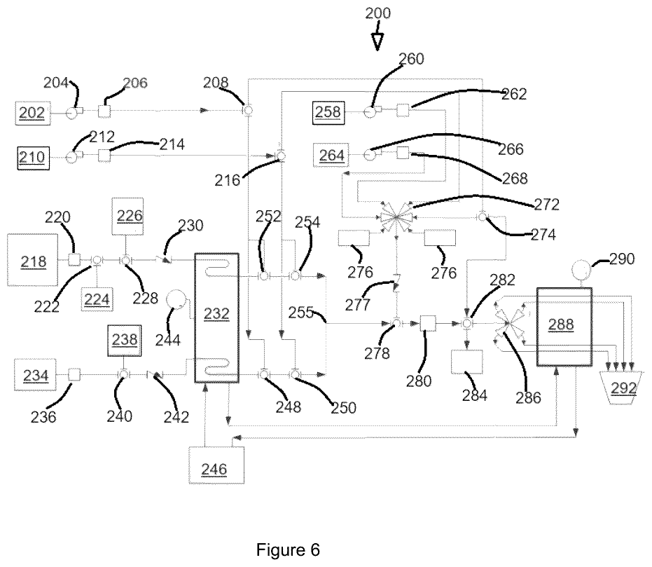

One embodiment illustrated in FIG. 6 relates to a system 200 for waveguide fabrication or deposition which includes several high-pressure pumps, selector valves, crossover valves, and hoses or tubing (stainless steel tubing for example) designed to deliver waveguide precursor chemicals under a specified regime of flow and pressure unique to the production of visible wave waveguides. In one embodiment, this system 200 fabricates one waveguide 10 at a time, while other embodiments fabricate multiple waveguides 10 sequentially.

Specifically, FIG. 6 depicts a waveguide fabrication system 200 including a deionized (DI) water reservoir, tank, or beaker 202 fluidly communicating with pump 204 which in turn communicates with filter 206 and valve 208 (a ball valve for example). Nitric Acid reservoir, tank, or beaker 210 is shown fluidly communicating with pump 212, filter 214, and valve 216 (a ball valve for example).

System 200 includes a Tolens Reagent/DI water reservoir, tank or beaker 218 fluidly communicating with filter 220, valve 222 (a ball valve for example), a waste reservoir, tank, or beaker 224, a Tolens Reagent Syringe Pump 226, valve 228 (a ball valve for example), valve 230 and heat exchanger 232 having temperature sensor 244. FIG. 6 further details a reducer/DI water reservoir, tank, or beaker 234 which is in fluid communication with filter 236, reducer syringe pump 238, valve 240 (a ball valve for example), valve 242, and heat exchanger 232. As shown, the heat exchanger 242 fluidly communicates with circulating chiller 246.

System 200 includes valves 248, 250, 252, and 254 (ball valves for example). Valve 248 is shown in fluid communication with the heat exchanger 232, and valves 208, 250, and 252. Valve 250 is shown in fluid communication with valves 216, 248, and 254, and valve 278. Valve 252 is shown in fluid communication with valves 208, 248, and 254. Valve 254 is shown in fluid communication with valves 216, 250, 252, and 278.

FIG. 6 further reveals a sensitizer reservoir, tank, or beaker 258 fluidly communicating with pump 260, filter 262, and one port of valve 272 (a 6-way valve for example). The figure further reveals an activator reservoir, tank, or beaker 264 fluidly communicating with a pump 266, a filter 268, and a port of valve 272. In turn valve 272 is shown in fluid communication with two spares 276.

Valve 272 is shown in fluid communication with filters 262 and 268, spares 276, and valves 216, 274, 277. Valve 274 is shown in fluid communication with valve 208, 272 and 282 while valve 277 is shown in fluid communication with valves 278 (a ball valve for example) and valve 272. Valve 278 is shown in fluid communication with filter 280, and valves 250, 254 and 282 (a ball valve for example). A waste reservoir, tank, or beaker 284 is shown fluidly communicating with valve 282, which in turn is in fluid communication with valves 274 and 286 (a 4-way valve for example), water bath 288 having temperature sensor 290, and waste reservoir, tank or beaker 292. FIG. 6 further illustrates that water bath 288 fluidly communicates with heat exchanger 232 and circulating chiller 246.

In one embodiment, the waveguide deposition system 200 for forming a waveguide 100 having low surface roughness which is adapted to minimize loss and noise while producing a circular beam that can be used in the visible or short-wave spectral regime, includes at least a constant temperature water bath 188 adapted to receive one or more hollow glass capillary tubes 150 and reduce the temperature of the one or more glass capillary tubes 150 to about 10° C.-15° C. for example.

In one or more embodiments hollow capillaries 150 (bare semi-flexible glass capillaries for example) similar to that illustrated in FIG. 5 are loaded into the system 200. The capillaries may be connected to compression fittings using soft graphite or vessel ferrules (not shown). The hollow capillaries 150 are positioned in the constant temperature water bath 288 where the temperature of the bath is controlled using at least the chiller 246 to maintain the temperature of the capillaries 150 at about 10-15° C. The lower temperature helps to ensure a smooth coating by slowing the formation of silver particles. A cover (not shown) is positioned over the water bath 288 to exclude ambient light from the capillaries 150 during the coating process, to prevent photochemical reaction during the process, and produce a higher quality coating.

In the illustrated embodiment, a filter 280 (a fine filter (2 μm) for example) precedes the bath 288 and is adapted to remove particles before the solutions flow to the capillary 150. The system 200 contains an array of peristaltic pumps designed to deliver cleaning and pre-treatment chemicals through the waveguides. Control of the pressure and temperature during this cleaning phase must be sufficient such that enough of each chemical flows to completely clean and treat the capillary 150. All the capillaries 150 are cleaned using concentrated nitric acid provided by nitric acid reservoir 210, pump 212, and filter 214, followed by a deionized (DI} water rinse provided by DI water reservoir 202, pump 204, and filter 206.

In one embodiment, the capillaries 150 are activated using an activator (tin (II) chloride solutions for example) provided by activator reservoir 264, pump 266, and filter 268, followed by a DI water rinse. The activator helps adhere the metal (silver metal for example) to the interior surface 154 of the capillaries 150. System 200 uses a set of high-pressure syringe pumps 226 and 238 (Teledyne Isco syringe pumps for example) to deliver Tollens Reagent and Reducer solutions through the capillaries 150 to coat them with silver internally. In at least one embodiment, the Tollens Reagent and reducer solutions are pumped at 3 ml per minute each and are mixed through a small volume t-fitting 255 fluidly communicating with valves 250, 254 and 278.

It should be appreciated that, due to the delicate nature of this solution (the mixed Tollens Reagent and reducer solution), the solution must be delivered to the capillary 150 at the right time after mixing, and at a specific flow rate. Also, the exact mixing of the Tollens and Reducer solution must be controlled by sending the first portion of the mixed solution into a waste stream in waste reservoir 284, then diverting the mixed solution through the capillaries 150, then diverting any remainder to a waste stream in waste reservoir 284. This is critical to coating uniformity. In one embodiment, the Tollens and Reducer syringe pumps 226 and 238 are kept pumping during the entire coating process, and the mixed solutions are not allowed to remain idle in any line or fitting.

The glass capillaries 150 are then plated by pumping the Tollen's reagent and the reducer solutions simultaneously at a constant flow rate of 3 ml/min for about 3 minutes each, followed by DI water rinse to stop the reaction. This flow rate (when applied to a 300 μm, 1 m length capillary} requires about 300 psig pressure at the syringe pumps. After silver plating and rinsing the capillaries, each capillary 150 is dried by flowing clean dry nitrogen through them for about 5-10 minutes at about 30 psig. The silvered waveguides may then be tested to compare performance via laser throughput and when in use as a Raman gas cell (as described previously).

FIG. 6 illustrates at least one bypass/crossover valve 186 in fluid communication with the constant temperature water bath 288; a first high-pressure syringe pump 226 in fluid communication with at least one bypass/crossover valve 286 and a first reservoir 218 containing a Tollens solution; and a second high-pressure syringe pump 238 in fluid communication with the at least one bypass/crossover valve 286 and a second reservoir 234 containing a reducer solution.

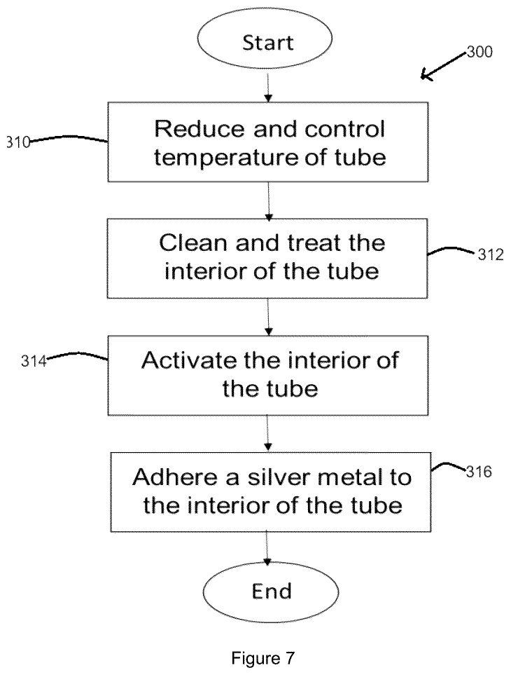

FIG. 7 depicts a flowchart illustrating one method generally designated 300 for forming a waveguide having low surface roughness which is adapted to minimize loss and noise while producing a circular beam that can be used in the visible or short-wave spectral regime similar to that provided previously. In accordance with one embodiment, method 300 includes reducing and controlling the temperature of one or more glass capillary tubes to about 10° C.-15° C., block 310. In one or more embodiments, method 300 can include reducing the temperature of the one or more glass capillary tubes by placing the one or more glass capillary tubes in a constant temperature water bath. Additionally, the ambient light around the at least one or more glass capillary tubes may be reduced by placing a cover over the constant temperature water bath.

Method 300 further includes cleaning and treating at least an interior of the one or more glass capillary tubes block 312. Cleaning and treating at least the interior of the one or more glass capillary tubes may include flowing Nitric Acid through the interior of the one or more glass capillary tubes and rinsing the interior of the at least one glass capillary tubes with deionized water.

Additionally, method 300 includes activating the interior of the one or more glass capillary tubes block 314 and adhering a silver metal to the interior of the one or more glass capillary tubes, block 316. Adhering a silver metal to the interior of the one or more glass capillary tubes may include flowing a mixed Tollens and Reducer solution through the interior of the one or more glass capillary tubes, ensuring a steady laminar flow through the interior of the one or more glass capillary tubes. In one or more embodiments this may include discarding an initial flow of mixed Tollens and Reducer solution, flowing only a thoroughly mixed portion of mixed Tollens and Reducer solution through the interior of the one or more glass capillary tubes, and discarding a remaining solution of the mixed Tollens and Reducer solution after deposition. Additional embodiments include sequentially reducing the temperature, cleaning and treating, activating; and adhering a silver metal to the interior of a plurality of glass capillary tubes.

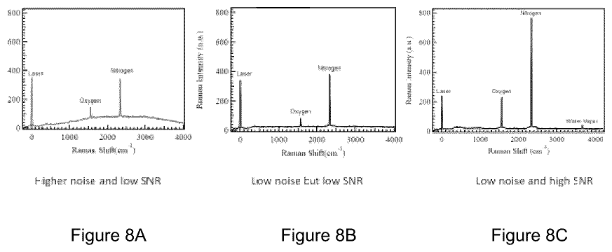

FIGS. 8A-8C depict plots illustrating Raman spectra of air from three waveguides of internal diameter 300 μm where FIG. 8A depicts a plot illustrating a known waveguide with higher noise and low SNR, FIG. 8B depicts a plot illustrating a known waveguide with low noise and low SNR, and FIG. 8C depicts a plot illustrating a waveguide in accordance with one embodiment of the present invention with low noise and high SNR.

In one or more embodiments described here, several features improve the wet chemical deposition method to produce high-quality visible-regime waveguides. To prepare the waveguides, standard peristaltic pumps are used for cleaning and sensitization solutions. Then, high-pressure syringe pumps (different from other known systems) are used to dispense the Tollens and Reducer solutions, thus ensuring steady laminar flow inside the capillary during electroless metal deposition. The initial mixing of the Tollens solution was found to be erratic, so a bypass valve is used to dispose of the initially mixed Tollens reagent. Once the solutions have flowed enough to ensure that a uniform mixture is being delivered, the bypass valve is switched from “waste bypass” to flowing through the capillary. This bypass valve method also ensures that the operator can exactly record the time of deposition from the moment the valve is switched to the moment it is switched back. 300 μm bore, 1 m long waveguides are plated for 3 minutes each at about 15° C. and 3 ml/minute of each reagent. This represents an optimal coating time for visible-wave waveguides of this size. The optimal flow rate and deposition time are known to be functions of the waveguide size, and optimal times and flow rates have been determined for a number of waveguide sizes of interest. The resultant waveguides produced with this method are of higher quality than commercially produced waveguides and are the highest quality of any hollow waveguide in the visible regime.

It should be appreciated that embodiments of the present invention include one or more features: High-pressure syringe pumps provide Tollens and Reducer solutions ensuring steady laminar flow inside the capillary during coating; Monitoring and control of reagent flow rate through the capillary being coated, enables optimum flow rate values to be determined (3 ml/minute for 300 μm capillary); Bypass (crossover) valves are used to discard initial flow of mixed Tollens/Reducer solutions, such that only the thoroughly mixed portion of the flow flows through the capillary, and enables discarding the remaining solutions after deposition rather than flow them through the capillary; Bypass valves maintain the continuous flow of the coating solutions throughout the run; Bypass valves provide the exact timing of the application of mixed reagents to the capillary being coated; Timing of the solution flow rate ensures exact deposition time applied. One or more embodiments enables determining the optimal coating time and temperature for a particular capillary (a 3 minute coating time at 15° C. for a 300 μm capillary for example). One or more embodiments enables sequential coating of multiple capillaries to provide the exact same deposition characteristics to each capillary, rather than parallel processing which can lead to some bad capillaries due to flow restrictions or other irregularities. Water bath used to control the temperature of the capillary being coated, as well as the coating reagents during and after mixing. Finally, bare glass thick-walled capillaries are used as waveguide feedstock to eliminate noise such as background fluorescence in Raman applications.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. A waveguide having low surface roughness, adapted to minimize loss and noise while producing a circular beam that can be used in the visible or short-wave spectral regime, the waveguide comprising:
a glass capillary tube having an outer surface and an inner surface defining a hollow core;
a metal layer deposited on at least the inner surface; and
a polymer layer overcoat deposited on at least the metal layer and in fluid communication with the hollow core.

2. The waveguide of claim 1 wherein the glass capillary tube is comprised of a semi-flexible glass capillary.

3. The waveguide of claim 1 wherein the metal layer is a silver metal plate plated on the inner surface of the glass capillary tube.

4. The waveguide of claim 1 wherein the polymer layer is comprised of a cyclic olefin copolymer.

5. The waveguide of claim 1 wherein the hollow core has a diameter of about 300 μm.

6. The waveguide of claim 1 wherein the glass capillary tube is about 1 meter in length.

7. A system for forming a waveguide having low surface roughness which is adapted to minimize loss and noise while producing a circular beam that can be used in the visible or short-wave spectral regime, the system comprising:
a constant temperature water bath adapted to receive one or more hollow glass capillary tubes and reduce the temperature of the one or more glass capillary tubes to about 10° C.-15° C.;
at least one bypass/crossover valve in fluid communication with the constant temperature water bath;
a first high-pressure syringe pump in fluid communication with the at least one bypass/crossover valve and a first reservoir containing a Tollens solution; and
a second high-pressure syringe pump in fluid communication with the at least one bypass/crossover valve and a second reservoir containing a reducer solution.

8. The system of claim 7 further comprising a circulating chiller in fluid communication with at least the constant temperature water bath.

9. The system of claim 7 further comprising a heat exchanger in fluid communication with at least the constant temperature water bath.

10. The system of claim 7 further comprising a deionized water reservoir in fluid communication with at least the constant temperature water bath.

11. The system of claim 7 further comprising a Nitric Acid reservoir in fluid communication with at least the constant temperature water bath.

12. The system of claim 7 further comprising a sanitizer reservoir in fluid communication with at least the constant temperature water bath.

13. The system of claim 7 further comprising an activator reservoir in fluid communication with at least the constant temperature water bath.

14. A method for forming a waveguide having low surface roughness which is adapted to minimize loss and noise while producing a circular beam that can be used in the visible or short-wave spectral regime, the method comprising:
reducing and controlling the temperature of one or more glass capillary tubes to about 10° C.-15° C.;
cleaning and treating at least an interior of the one or more glass capillary tubes;
activating the interior of the one or more glass capillary tubes; and
adhering a silver metal to the interior of the one or more glass capillary tubes.

15. The method of claim 14 wherein reducing the temperature of the one or more glass capillary tubes comprises placing the one or more glass capillary tubes in a constant temperature water bath.

16. The method of claim 15 further comprising reducing ambient light around the at least one or more glass capillary tubes by placing a cover over the constant temperature water bath.

17. The method of claim 14 wherein cleaning and treating at least the interior of the one or more glass capillary tubes comprises flowing Nitric Acid through the interior of the one or more glass capillary tubes and rinsing the interior of the at least one glass capillary tubes with deionized water.

18. The method of claim 14 wherein adhering a silver metal to the interior of the one or more glass capillary tubes comprises flowing a mixed Tollens and Reducer solution through the interior of the one or more glass capillary tubes, ensuring a steady laminar flow through the interior of the one or more glass capillary tubes.

19. The method of claim 18 wherein flowing the mixed Tollens and Reducer solution through the interior of the one or more glass capillary tubes comprises discarding an initial flow of mixed Tollens and Reducer solution, flowing only a thoroughly mixed portion of mixed Tollens and Reducer solution through the interior of the one or more glass capillary tubes, and discarding a remaining solution of the mixed Tollens and Reducer solution after deposition.

20. The method of claim 14 further comprising sequentially reducing the temperature, cleaning and treating, activating; and adhering a silver metal to the interior of a plurality of glass capillary tubes.
